(19) United States
(12) Patent Application Publication
(10) Pub. No.: US 2014/0356824 A1
(43) Pub. Date: Dec. 4, 2014

(54) SYSTEM AND METHOD FOR TREATMENT OF STIMULI INDUCED PSYCHOLOGICAL DISORDERS

(71) Applicant: THOMAS HUDSON DOZIER, LIVERMORE, CA (US)

(72) Inventor: Thomas Hudson Dozier, Livermore, CA (US)

(21) Appl. No.: 14/295,217

(22) Filed: Jun. 3, 2014

Related U.S. Application Data
(60) Provisional application No. 61/831,116, filed on Jun. 4, 2013.
(60) Provisional application No. 61/857,070, filed on Jul. 22, 2013.
(60) Provisional application No. 61/869,683, filed on Aug. 24, 2013.
(60) Provisional application No. 61/837,432, filed on Jun. 20, 2013.

(51) Int. Cl. G09B 5/06; G09B 23/28

(52) U.S. Cl. CPC G09B 5/06; G09B 23/28
USPC 434/236

(57) ABSTRACT

A patient may be treated for a psychological disorder, such as misophonia or a phobia, through the use of a system and method. The method may store a trigger media set in a data store; the trigger media set may include one or more trigger media files that encode audio, visual, and/or audiovisual trigger stimuli known to trigger the psychological disorder. A treatment plan may also be stored in the data store; the treatment plan may include at least a first trigger selection of a first trigger media file from the trigger media set. A processor may execute the treatment plan by intermittently initiating playback of the first trigger selection for the patient, through a first output device. This playback may be mixed with exposure of the patient to positive stimuli, which may also be included in the treatment plan and provided through the first output device.

### CROSS-REFERENCE TO RELATED APPLICATIONS

The present application claims the benefit of U.S. Provisional Application Ser. No. 61/831,116, Attorney's Docket No. THD-1 PROV, entitled SYSTEM AND METHOD FOR MISOPHONIA TREATMENT, which was filed on Jun. 4, 2013. The present application also claims the benefit of U.S. Patent Application Ser. No. 61/857,070, Attorney's Docket No. THD-2 PROV, entitled SOFTWARE AND METHOD FOR MISOPHONIA TREATMENT, which was filed on Jul. 22, 2013. The present application also claims the benefit of U.S. Patent Application Ser. No. 61/869,683, Attorney's Docket No. THD-3 PROV, entitled AUDIOVISUAL MISOPHONIA TREATMENT, which was filed on Aug. 24, 2013. The present application also claims the benefit of U.S. Patent Application Ser. No. 61/873,432, Attorney's Docket No. THD-4 PROV, entitled TREATMENT METHODS AND APPARATUS FOR MISOPHONIA AND PHOBIAS, which was filed on Sep. 4, 2013. The foregoing applications are incorporated by reference as though set forth herein in their entirety.

### TECHNICAL FIELD

The present invention relates to systems and methods for treating sensitivities to sensory input. More specifically, the present invention relates to computer-implemented systems and methods that facilitate the treatment of stimuli induced psychological disorders such as misophonia and phobias.

### BACKGROUND

Recent advancements in psychology and behavioral science have revealed the presence of a variety of behavioral disorders. Many such disorders have symptoms that include extraordinary reactions to certain stimuli. Two examples are misophonia and phobias.

Misophonia is characterized by a strong emotional reaction of anger, rage, hate, annoyance, resentment, or being offended to soft sounds such as eating, breathing, muffled sounds, typing, or any other repeating sound. A person experiencing misophonia generally has normal hearing. It is not a sensitivity to the volume of sound, but an emotional reaction to specific soft sounds or sounds made by specific individuals. The reactions that occur with misophonia may be associated with a specific individual. For example, the chewing sound of a friend may be annoying, while the chewing sound of a parent elicits a strong emotional reaction. The sound that elicits the misophonia reaction is called a trigger or trigger stimulus.

In contrast, phobias are characterized by a fear reaction to a stimulus. For phobias, the visual image, sound, spoken words, or any other stimulus that elicits the phobic reaction is a trigger or a trigger stimulus for the phobia.

In both cases, the patient may suffer from feelings of fear, anger, anxiety, or the like. The person may feel embarrassment or shame due to their perception that they are mentally defective, or possess inadequate self-control. Many people with such conditions are forced to restructure their living circumstances or habits to avoid the trigger stimuli, and even with such changes, must live in fear that they will be unexpectedly exposed to trigger stimuli, and will then be unable to control their reaction. Accordingly, there is a need in the art for treatment systems and methods that overcome the shortcomings of the prior art.

### SUMMARY OF THE INVENTION

The various systems and methods of the present invention have been developed in response to the present state of the art, and in particular, in response to the problems and needs in the art that have not yet been fully solved by currently available psychological disorder treatments. The systems and methods of the present invention may provide relief from stimulus-triggered psychological disorders such as misophonia and phobias.

There is an accompanying physiological reaction with both a misophonia anger reaction and the phobia fear reaction. The physiological reaction is a respondent behavior, which is a conditioned reflex to the trigger stimulus. Misophonia and phobias trigger different physiological reactions.

The physiological misophonic reaction appears to be an involuntary reflex caused by the sound. The sound directly activates the Autonomic Nervous System which is located in the brain stem and the Limbic System which is associated with emotion. This is called a “low road” response. It is a direct connection between the sound and a reflex reaction. The reaction elicited by the sound may be comparable to the reaction that may occur in response to abrupt physical contact, such as a hard poke in the ribs with a stick.

The physiological phobia reaction appears to be the same mechanisms as the misophonic reaction just described. With phobias, the trigger is frequently visual; with misophonia, the trigger is typically sound. However, with both misophonia and phobias, the trigger can be any form of stimulus—sound, a visual image, words, a smell, or even a thought. It is theoretically possible to have triggers of touch or taste, but this is not common.

Behavioral science explains this physiological reaction as a “respondent” or “reflex” behavior that has been acquired (conditioned) or developed by pairing the sound with a distressed (stress, anxiety, etc.) physiological condition. Technically, this is called a “learned conditioned response,” but it has no connection to “learning” in the ordinary sense. It is simply a neurological pairing of the sound, sight, or any other stimulus and physiological distress. It is “learned” in the respect that it was not an innate or inborn reaction, and hence may be termed an “acquired reflex.” It is a reflex because it is a direct connection from a sense (hearing, sight, etc.) and the autonomic nervous system.

Misophonia seems to occur more frequently in a person with a higher level of anxiety, stress, or compulsive behavior. The reaction usually develops first to a parent or family member where the person has a high level of anxiety or distress (physiological state of distress) and they repeatedly hear the sound. It also seems to happen when a person cannot escape from the sound, such as at the dinner table, in a car, or even lying in bed. In contrast, phobias develop when there is a particular class of stimuli (for example, images of spiders, real spiders, and/or words about spiders) that are associated with a natural fear or pain reaction.

With most sounds, the sound registers in the brain and then the person makes a thoughtful response. The person considers the meaning of the sound and then responds. This is called a “high road” response. For example, if a person says something that would ordinarily be offensive to a second person, the second person will typically think about the words and the meaning prior to responding. Contextual elements, such as previous statements in a conversation indicating that the offensive remark is a joke, may cause the second person to avoid the negative emotional response that might otherwise ensue. If no such contextual elements are present, the second person may have a strong, negative emotional response, such as crying. The same process typically occurs for visual images (or other stimuli) and phobic reactions. Most sights and other stimuli are thoughtfully considered, and fear may or may not occur because of the stimulus.

With both misophonia and phobias, there is a conditioned reflex response to the trigger stimulus that is physiological reaction. This reaction can include constricting or relaxing of muscles, release of hormones by glands, or other respondent behavior such an increase in heart rate, sweating, or any other physical reflex reaction. Rational thought processes may not be effective in avoiding the conditioned reflex response.

Thus, those who suffer from such psychological disorders may be quite helpless to prevent the reactions they have to the associated stimuli. Known treatments, such as counselling, medication, or traditional therapeutic techniques, may be ineffective at treating psychological disorders such as misophonia and phobias.

However, some patients have experienced relief from treatments designed to disassociate the trigger stimuli from the underlying emotions. When exposed to agreeable stimuli, some patients develop a higher tolerance for the trigger stimuli. Such treatment methods may be beneficially administered through the use of a computing system such as a computer, smartphone, tablet, or the like. Advantageously, the patient may then tailor the treatment to his or her specific needs, and may generally feel more in control of his or her mental well-being.

In some embodiments, the method may be administered by storing a trigger media set in a data store; the trigger media set may include one or more trigger media files that encode audio, visual, and/or audiovisual trigger stimuli known to trigger the psychological disorder. A treatment plan may also be stored in the data store; the treatment plan may include at least a first trigger selection of a first trigger media file from the trigger media set. If desired, more than one selection may be included in the treatment plan to enable playback of more than one trigger media file. A processor may execute the treatment plan by intermittently initiating playback of the trigger media file(s) for the patient, through one or more output devices. The output devices may include a speaker and/or a display screen, depending on whether the trigger media file(s) are auditory, visual, or audiovisual.

This playback may be mixed with exposure of the patient to agreeable stimuli, which may also be included in the treatment plan and provided through the first output device. In some embodiments, the agreeable stimuli may be encoded in one or more agreeable media files stored in the data store. The treatment plan may include at least a first agreeable selection of a first agreeable media file from the agreeable media set. If desired, the treatment plan may include multiple agreeable selections that define a playlist, with an order of playback defined by the user (which may be the patient).

Playback may commence with the agreeable media file(s), and the trigger media file(s) may play intermittently during playback of the agreeable media file(s). The agreeable media file(s) may continue to play concurrently with the trigger media file(s), pause while the trigger media files play, and/or reduce in volume while the trigger media file(s) play. The patient may have the ability to select various parameters of how the treatment plan will be executed, such as:
The length of playback of each media file;
The volume of playback of each media file;
The order in which media files are to be played;
The length of the treatment plan;
The relative playback volume and/or relative volume change between instances of playback of the media file(s);
The time increment and/or time increment variation between instances of playback of the trigger media file(s); and
Other parameters.

Thus, the patient may have a high degree of control over the treatment plan. Additionally, as the patient progresses, the treatment plan may easily be modified to provide more aggressive treatment, longer treatments, or the like.

Several patients have responded favorably to the application of the systems and methods of the present invention. In some patients, trigger stimuli have been effectively neutralized, enabling them to enjoy life free of the fear that they will unexpectedly be subjected to emotional reactions they cannot control.

These and other features and advantages of the present invention will become more fully apparent from the following description and appended claims, or may be learned by the practice of the invention as set forth hereinafter.

### BRIEF DESCRIPTION OF THE DRAWINGS

Exemplary embodiments of the invention will become more fully apparent from the following description and appended claims, taken in conjunction with the accompanying drawings. Understanding that these drawings depict only exemplary embodiments and are, therefore, not to be considered limiting of the invention's scope, the exemplary embodiments of the invention will be described with additional specificity and detail through use of the accompanying drawings in which:

FIG. 1 is a schematic block diagram illustrating a system according to one embodiment of the invention.

FIG. 2A is a schematic block diagram illustrating a computing device in the form of the smartphone of FIG. 1, which is capable of practicing the invention in a standalone computing environment.

FIG. 2B is a schematic block diagram illustrating a computing device in the form of the desktop computer of FIG. 1, and a server in the form of the first server of FIG. 1, which may cooperate to enable practice of the invention with client/server architecture.

FIG. 3 is a schematic block diagram illustrating a schema in which data may be processed and/or utilized to provide treatment for a psychological disorder, according to one embodiment of the invention.

FIG. 4 is a flowchart diagram illustrating a method of providing treatment for a psychological disorder, according to one embodiment of the invention.

FIG. 5 is a screenshot illustrating a home screen according to one embodiment of the invention.

FIG. 6 is a screenshot illustrating a playlist creator screen according to one embodiment of the invention.

FIG. 7 is a screenshot illustrating a trigger creator screen according to one embodiment of the invention.

FIG. 8 is a screenshot illustrating a playlist view screen according to one embodiment of the invention.

FIG. 9 is a screenshot illustrating a triggerlist view screen according to one embodiment of the invention.

FIG. 10 is a screenshot illustrating a treatment screen according to one embodiment of the invention.

FIG. 11 is a screenshot illustrating a settings screen according to one embodiment of the invention.

FIG. 12 is a screenshot illustrating a history screen according to one embodiment of the invention.

FIG. 13 is a screenshot illustrating an audio browser screen according to one embodiment of the invention.

### DETAILED DESCRIPTION

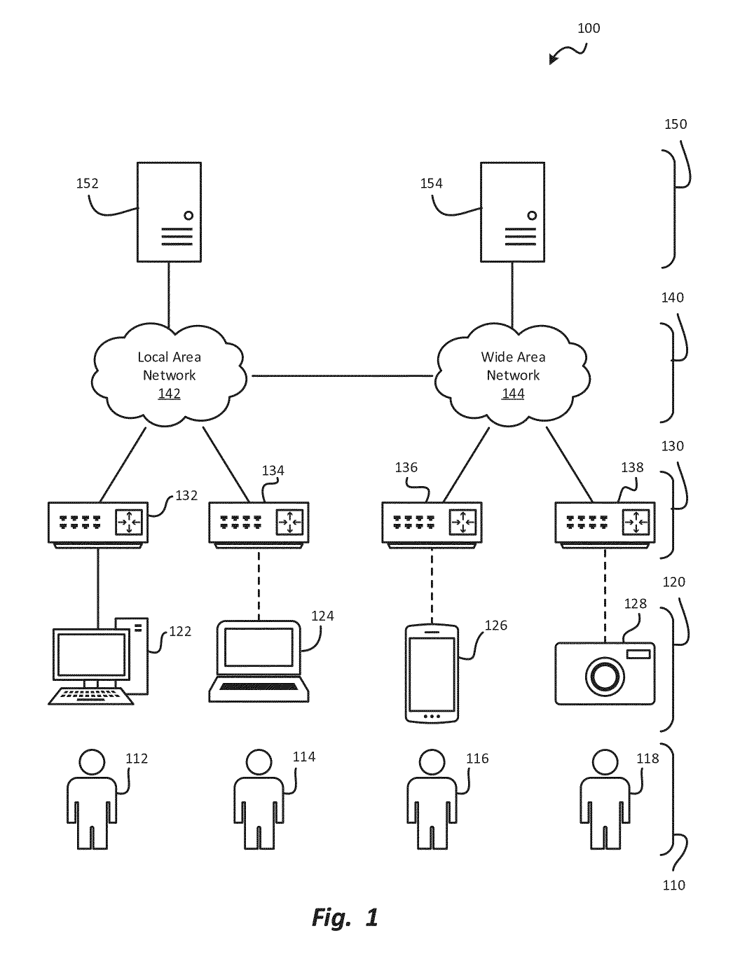

Exemplary embodiments of the invention will be best understood by reference to the drawings, wherein like parts are designated by like numerals throughout. It will be readily understood that the components of the invention, as generally described and illustrated in the Figures herein, could be arranged and designed in a wide variety of different configurations. Thus, the following more detailed description of the embodiments of the apparatus, system, and method, as represented in FIGS. 1 through 13, is not intended to limit the scope of the invention, as claimed, but is merely representative exemplary of exemplary embodiments of the invention.

The phrases “connected to,” “coupled to” and “in communication with” refer to any form of interaction between two or more entities, including mechanical, electrical, magnetic, electromagnetic, fluid, and thermal interaction. Two components may be functionally coupled to each other even though they are not in direct contact with each other. The term “abutting” refers to items that are in direct physical contact with each other, although the items may not necessarily be attached together. The phrase “fluid communication” refers to two features that are connected such that a fluid within one feature is able to pass into the other feature.

The word “exemplary” is used herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

Referring to FIG. 1, a schematic block diagram illustrates a system 100 according to one embodiment of the invention. The system 100 may be used for the benefit of one or more users 110, which may include a first user 112, a second user 114, a third user 116, and a fourth user 118 as shown in FIG. 1. Each of the users 110 may use one of a variety of computing devices 120, which may include any of a wide variety of devices that carry out computational steps, including but not limited to a desktop computer 122 used by the first user 112, a laptop computer 124 used by the second user 114, a smartphone 126 used by the third user 116, a camera 128 used by the fourth user 118, and the like. The system and method presented herein may be carried out on any type of computing device.

The computing devices 120 may optionally be connected to each other and/or other resources. Such connections may be wired or wireless, and may be implemented through the use of any known wired or wireless communication standard, including but not limited to Ethernet, 802.11a, 802.11b, 802.11g, and 802.11n, universal serial bus (USB), Bluetooth, cellular, near-field communications (NFC), Bluetooth Smart, ZigBee, and the like. In FIG. 1, by way of example, wired communications are shown with solid lines and wireless communications are shown with dashed lines.

Communications between the various elements of FIG. 1 may be routed and/or otherwise facilitated through the use of routers 130. The routers 130 may be of any type known in the art, and may be designed for wired and/or wireless communications through any known communications standard including but not limited to those listed above. The routers 130 may include, for example, a first router 132 that facilitates communications to and/or from the desktop computer 122, a second router 134 that facilitates communications to and/or from the laptop computer 124, a third router 136 that facilitates communications to and/or from the smartphone 126, and a fourth router 138 that facilitates communications to and/or from the camera 128.

The routers 130 may facilitate communications between the computing devices 120 and one or more networks 140, which may include any type of networks including but not limited to local area networks such as a local area network 142, and wide area networks such as a wide area network 144. In one example, the local area network 142 may be a network that services an entity such as a business, non-profit entity, government organization, or the like. The wide area network 144 may provide communications for multiple entities and/or individuals, and in some embodiments, may be the Internet. The local area network 142 may communicate with the wide area network 144. If desired, one or more routers or other devices may be used to facilitate such communication.

The networks 140 may store information on servers 150 or other information storage devices. As shown, a first server 152 may be connected to the local area network 142, and may thus communicate with devices connected to the local area network 142 such as the desktop computer 122 and the laptop computer 124. A second server 154 may be connected to the wide area network 144, and may thus communicate with devices connected to the wide area network 144, such as the smartphone 126 and the camera 128. If desired, the second server 154 may be a web server that provides web pages, web-connected services, executable code designed to operate over the Internet, and/or other functionality that facilitates the provision of information and/or services over the wide area network 144.

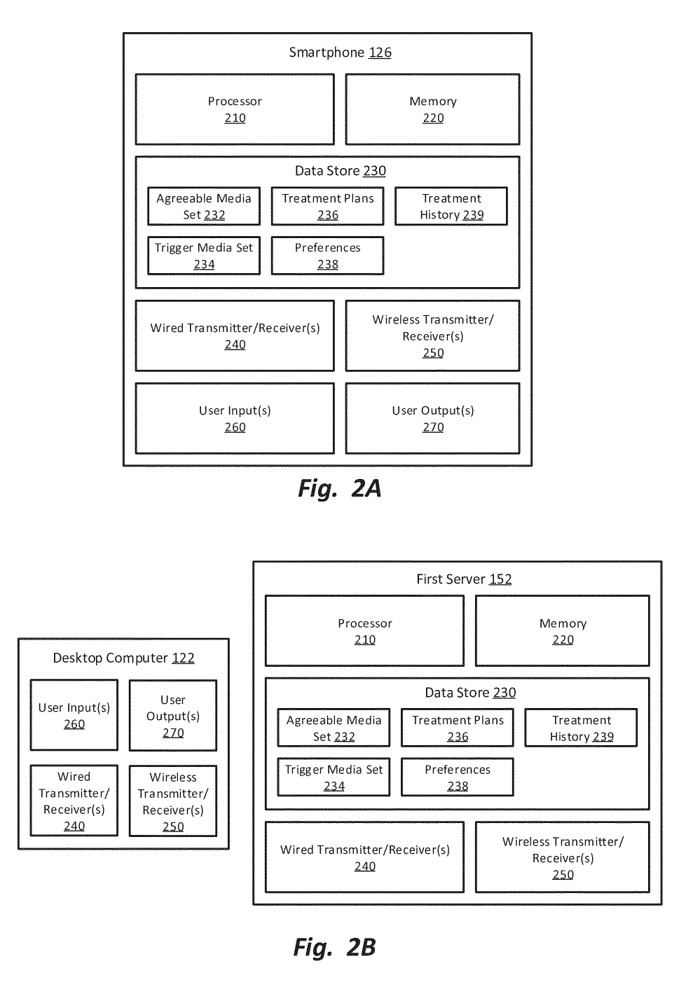

Referring to FIG. 2A, a schematic block diagram illustrates an exemplary computing device of the computing devices 120 that may enable implementation of the invention in a standalone computing environment. The computing device may be, for example, the smartphone 126 of FIG. 1.

As shown, the smartphone 126 may include a processor 210 that is designed to execute instructions on data. The processor 210 may be of any of a wide variety of types, including microprocessors with x86-based architecture or other architecture known in the art, application-specific integrated circuits (ASICs), field-programmable gate arrays (FPGA's), and the like. The processor 210 may optionally include multiple processing elements, or “cores.” The processor 210 may include a cache that provides temporary storage of data incident to the operation of the processor 210.

The smartphone 126 may further include memory 220, which may be volatile memory such as random access memory (RAM). The memory 220 may include one or more memory modules. The memory 220 may include executable instructions, data referenced by such executable instructions, and/or any other data that may beneficially be made readily accessible to the processor 210.

The smartphone 126 may further include a data store 230, which may be non-volatile memory such as a hard drive, flash memory, and/or the like. The data store 230 may include one or more data storage elements. The data store 230 may store executable code such as an operating system and/or various programs to be run on the smartphone 126. The data store 230 may further store data to be used by such programs. For the system and method of the present invention, the data store 230 may store an agreeable media set 232, a trigger media set 234, one or more treatment plans 236, one or more preferences 238, and/or treatment history 239.

The present invention may utilize repeated trigger stimuli, intermingled with the presence of agreeable stimuli, to treat misophonia, phobias, and/or other psychological disorders. The agreeable media set 232 represents an optional inclusion in the data store 230 because agreeable stimuli may be provided through the use of other methods not associated with a computing device. If included, the agreeable media set 232 may include one or more agreeable media files that encode agreeable stimuli known to be agreeable to the user. The agreeable media files may include audio, visual, and/or audiovisual stimuli such as music, sounds, pictures, moving images, and/or video clips that engender feelings of well-being in the patient.

The trigger media set 234 may include one or more trigger media files that encode trigger stimuli known to trigger symptoms of the psychological disorder. The trigger stimuli may include audio stimuli (such as music or sounds), visual stimuli (such as static images or moving images), and/or audiovisual stimuli (such as video clips). In the case of misophonia treatment, the trigger stimuli may include, for example, a sound and/or video clip of a person chewing or engaging in other activities that trigger the anxiety, hostility, or other reactions associated with misophonia. In the case of treatment for phobias, the trigger stimuli may include, for example, pictures or video clips of the subject of the patient's irrational or excessive fear.

Each of the treatment plans 236 may include one or more selections from the trigger media set 234 and, if used, one or more selections from the agreeable media set 232. Each of the treatment plans 236 may also include data regarding how the one or more agreeable media files and/or the one or more trigger media files are to be played. For example, each of the treatment plans 236 may include various parameters regarding the length of playback, recurrence timing, volume, clarity, and/or other playback characteristics of the agreeable media files of the agreeable media set 232 and/or the trigger media files of the trigger media set 234.

The preferences 238 may include default settings and/or user selections regarding various aspects of the operation of the system and method of the present invention. For example, the preferences 238 may include selections regarding the default parameters to be used in the creation and/or execution of the treatment plans 236, selections regarding the storage of the agreeable media files of the agreeable media set 232 and/or the trigger media files of the trigger media set 234.

The treatment history 239 may include a history of treatment plans that have been executed. The treatment plans of the treatment history 239 may be organized by date, and may include information such as the length of the treatment plan, the agreeable media file(s) used, the trigger media file(s) used, and/or other settings pertinent to the manner in which each treatment plan was carried out.

The smartphone 126 may further include one or more wired transmitter/receivers 240, which may facilitate wired communications between the smartphone 126 and any other device, such as the other computing devices 120, the servers 150, and/or the routers 130 of FIG. 1. The wired transmitter/receivers 240 may communicate via any known wired protocol, including but not limited to any of the wired protocols described in FIG. 1. In some embodiments, the wired transmitter/receivers 240 may include Ethernet adapters, universal serial bus (USB) adapters, and/or the like.

The smartphone 126 may further include one or more wireless transmitter/receivers 250, which may facilitate wireless communications between the smartphone 126 and any other device, such as the other computing devices 120, the servers 150, and/or the routers 130 of FIG. 1. The wireless transmitter/receivers 250 may communicate via any known wireless protocol, including but not limited to any of the wireless protocols described in FIG. 1. In some embodiments, the wireless transmitter/receivers 250 may include Wi-Fi adapters, Bluetooth adapters, cellular adapters, and/or the like.

The smartphone 126 may further include one or more user inputs 260 that receive input from a user such as the third user 116 of FIG. 1. The user inputs 260 may be integrated into the smartphone 126, or may be separate from the smartphone 126 and connected to it by a wired or wireless connection, which may operate via the wired transmitter/receivers 240 and/or the wireless transmitter/receivers 250. The user inputs 260 may include elements such as a touch screen, buttons, keyboard, mouse, trackball, track pad, stylus, digitizer, digital camera, microphone, and/or other user input devices known in the art.

The smartphone 126 may further include one or more user outputs 270 that provide output to a user such as the third user 116 of FIG. 1. The user outputs 270 may be integrated into the smartphone 126, or may be separate from the smartphone 126 and connected to it by a wired or wireless connection, which may operate via the wired transmitter/receivers 240 and/or the wireless transmitter/receivers 250. The user outputs 270 may include elements such as a display screen, speaker, vibration device, LED or other lights, and/or other output devices known in the art. In some embodiments, one or more of the user inputs 260 may be combined with one or more of the user outputs 270, as may be the case with a touch screen.

The smartphone 126 may include various other components not shown or described herein. Those of skill in the art will recognize, with the aid of the present disclosure, that any such components may be used to carry out the present invention, in addition to or in the alternative to the components shown and described in connection with FIG. 2A.

The smartphone 126 may be capable of carrying out the present invention in a standalone computing environment, i.e., without relying on communication with other devices such as the other computing devices 120 or the servers 150. In other embodiments, the present invention may be utilized in different computing environments. One example of a client/server environment will be shown and described in connection with FIG. 2B.

Referring to FIG. 2B, a schematic block diagram illustrates a computing device in the form of the desktop computer 122 of FIG. 1, and a server in the form of the first server 152 of FIG. 1, which may cooperate to enable practice of the invention with client/server architecture. As shown, the desktop computer 122 may be a “dumb terminal,” made to function in conjunction with the first server 152.

Thus, the desktop computer 122 may have only the hardware needed to interface with a user (such as the first user 112 of FIG. 1) and communicate with the first server 152. Thus, the desktop computer 122 may include one or more user inputs 260, one or more user outputs 270, one or more wired transmitter/receivers 240, and/or one or more wireless transmitter/receivers 250. These components may be as described in connection with FIG. 2A.

Computing functions (apart from those incident to receiving input from the user and delivering output to the user) may be carried out in the first server 152. Thus, the processor 210, memory 220, data store 230, wired transmitter/receivers 240, and wireless transmitter/receivers 250 may be housed in the first server 152. These components may also be as described in connection with FIG. 1A.

In operation, the desktop computer 122 may receive input from the user via the user inputs 260. The user input may be delivered to the first server 152 via the wired transmitter/receivers 240 and/or wireless transmitter/receivers 250. This user input may be further conveyed by any intervening devices, such as the first router 132 and any other devices in the local area network 142 that are needed to convey the user input from the first router 132 to the first server 152.

The first server 152 may conduct any processing steps needed in response to receipt of the user input. Then, the first server 152 may transmit user output to the user via the wired transmitter/receivers 240, and/or wireless transmitter/receivers 250. This user output may be further conveyed by any intervening devices, such as the first router 132 and any other devices in the local area network 142 that are needed to convey the user output from the first server 152 to the first router 132. The user output may then be provided to the user via the user outputs 270.

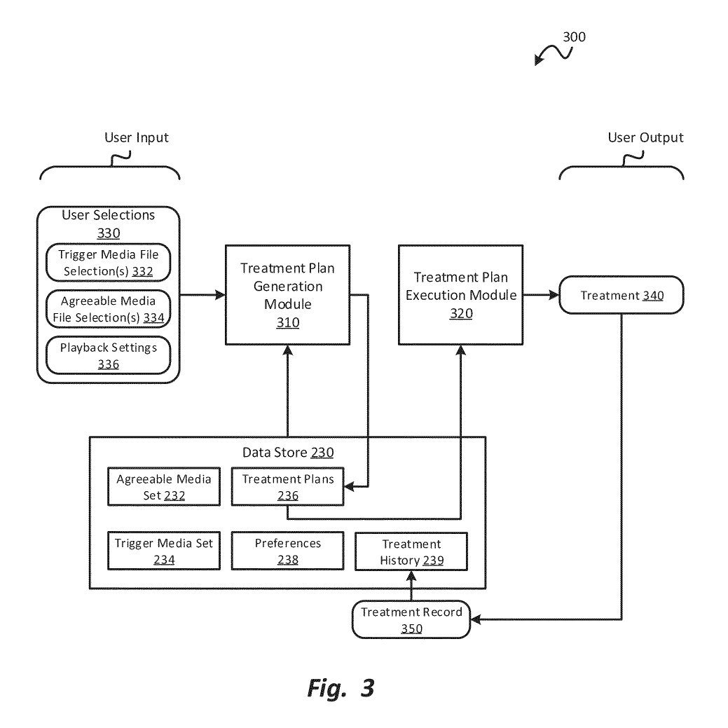

Referring to FIG. 3, a schematic block diagram illustrates a schema 300 in which data may be processed and/or utilized to provide treatment for a psychological disorder, according to one embodiment of the invention. As shown, the schema 300 may include a treatment plan generation module 310 and a treatment plan execution module 320. The treatment plan generation module 310 may receive, as inputs from the user, user selections 330. The user selections 330 may include any of a variety of treatment parameters, including but not limited to one or more trigger media file selections 332, one or more agreeable media file selections 334, and/or playback settings 336. Each of the trigger media file selections 332 may specify one of the trigger media files of the trigger media set 234 stored in the data store 230. Similarly, each of the agreeable file selections may specify an agreeable media file of the agreeable media set 232 stored in the data store 230. The playback settings 336 may provide treatment parameters, which may include, but need not be limited to:
The duration of playback of each trigger media file;
The duration of playback of each agreeable media file;
The order in which trigger media files are to be played (i.e., a triggerlist);
The order in which agreeable media files are to be played (i.e., a playlist);
The volume level at which playback of each trigger media file occurs;
The volume level at which playback of each agreeable media file occurs;
The length of the treatment plan;
The relative playback volume between the trigger media file(s) and the agreeable media file(s);
The amount of volume reduction applied to the agreeable media file(s) during playback of the trigger media file(s);
The time increment between iterations of playback of the trigger media file(s);
Whether such a time increment is constant or variable;
The volume change to be applied to sequential instances of playback of the trigger media file;
The volume change to be applied to the agreeable media file(s) over time; and/or
Other parameters.

The treatment plan generation module 310 may receive the user selections 330 and, based on the user selection 330, generate a treatment plan, which may be stored in the treatment plans 236 of the data store 230. The treatment plan may then be executed by the treatment plan execution module 320 at a time desired by the patient. The treatment plan execution module 320 may provide, as user output, a treatment 340. The treatment 340 may consist of various auditory, visual, and audiovisual stimuli, which may include trigger stimuli encoded in the trigger media files of the trigger media set 234 and optionally, agreeable stimuli encoded in the agreeable media files of the agreeable media set 232. If desired, the treatment 340 may include playback of only the trigger media file selection(s) 332; this treatment may then optionally be supplemented via provision of agreeable stimuli from a different source. Such alternative sources of agreeable stimuli may include, but are not limited to, activities undertaken by the patient, presence of the patient in an agreeable environment (such as a beach or wooded location), or the presence of one or more people whose companionship provides agreeable stimuli.

After the treatment 340 has been provided to the patient, a treatment record 350 with information regarding the treatment 340 may be stored as an entry in the treatment history 239. Various data regarding the treatment 340 may be stored in the treatment record 350, including but not limited to:
The trigger media file selection(s) 332;
The agreeable media file selection(s) 334;
The user selections 330;
The length of the treatment 340 that the patient actually underwent;
Any volume adjustments applied by the patient during the treatment; and
The number and duration of pauses in the treatment 340.

Thus, a user, such as the patient or a care provider, can easily see not only details incident to the creation of the treatment plan corresponding to the treatment 340, but also the manner which the treatment 340 was executed. Such information may be helpful in evaluating progress and/or putting together future treatment plans for the patient.

In some implementations, the schema 300 may be carried out through the use of a computer program product. Such a computer program product may be made available in tangible media, such as a CD-ROM, USB drive, or flash memory card, or intangibly via download or the like. Referring to the example of the smartphone 126 of FIG. 1, the schema 300 may be implemented as an app that can be downloaded for execution in a manner compatible with the operating system of the smartphone 126.

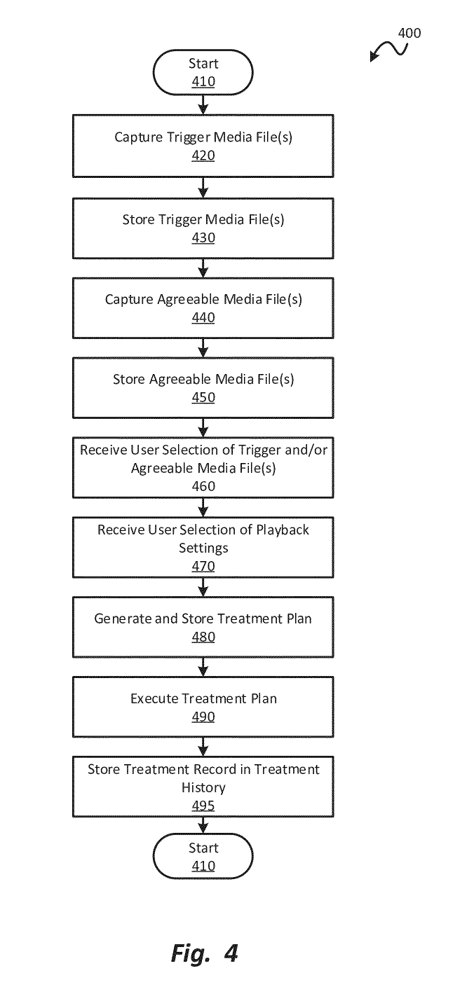

Referring to FIG. 4, a flowchart diagram illustrates a method 400 of providing treatment for a psychological disorder, according to one embodiment of the invention. The method 400 may be carried out through the use of any of the components of the system 100 of FIGS. 1-2B and/or using the schema 300 provided in FIG. 3. Alternatively, the method 400 may be carried out with hardware different from that of the system 100 of FIGS. 1-2B and/or a different schema from the schema 300 of FIG. 3. The following description of the method 400 is based on the exemplary use of the smartphone 126 of FIG. 1 and the schema 300 of FIG. 3. Many of the steps of the method 400 may be performed by the patient, by a treatment professional, or automatically without human intervention.

The method 400 may start 410 with a step 420 in which the one or more trigger media files of the trigger media set 234 are captured. This may be done, for example, through the use of the user input(s) 260. Such user inputs may include devices capable of capturing auditory, visual, and/or audiovisual media such as digital audio files, digital image files, and/or digital video files. Thus, the user input(s) 260 may include a digital camera, a microphone, and/or other input devices that can be used to capture such media in the step 420.

Notably, the step 420 is optional. Rather than capturing the trigger media file(s), trigger media files may be downloaded, or copied from a different source, such as an online library of trigger media files. If the method 400 is implemented via software, such as a smartphone app, some sample trigger media files may be provided along with the software. However, the misophonia or phobia trigger stimuli to which the patient is sensitive may be specific to certain situations, people, objects, or animals; thus, the ability to capture a trigger media file specific to the patient may enhance the effectiveness of the method 400.

Once the trigger media file(s) have been obtained, the method 400 may proceed to a step 430 in which the trigger media file(s) are stored. This may be done, for example, by storing the trigger media file(s) in the trigger media set 234 of the data store 230.

The method 400 may then proceed to a step 440 in which the agreeable media file(s) are captured. Like the step 420, the step 440 is optional—the agreeable media file(s) may be captured through the use of the user input(s) 260, or obtained via downloading or other mechanisms.

Once the agreeable media file(s) have been obtained, the method 400 may proceed to a step 450 in which the agreeable media file(s) are stored. This may be done, for example, by storing the agreeable media file(s) in the agreeable media set 232 of the data store 230. This step is optional because agreeable stimuli need not be included in the treatment, as described previously.

With the trigger media file(s) and/or the agreeable media file(s) successfully stored, the method 400 may proceed to a step 460 in which the smartphone 126 receives user input from the user, for example, the patient. Such user input may be received via the user input(s) 260 of the smartphone 126. The input received from the user may provide the trigger media file selection(s) 332 and, if agreeable stimuli are also to be provided by the smartphone 126, the agreeable media file selection(s) 334. This input may be received, for example, by allowing the user to select the trigger media file(s) and/or the agreeable media file(s) from a list, such as a list of the contents of the trigger media set 234 and the agreeable media set 232, respectively.

The method 400 may then proceed to a step 470 in which the playback settings 336 are also received. This user input may also be received via the user input(s) 260 of the smartphone 126. The input may specify parameters, as set forth previously, related to the manner in which the trigger media file(s) and/or the agreeable media file(s) are to be played for the patient during execution of the treatment plan.

The smartphone 126 may then have all user inputs needed to completely define the treatment plan. Thus, the method 400 may proceed to a step 480 in which the treatment plan is generated and stored, for example, in the treatment plans 236 stored in the data store 230. The treatment plan may then be ready for execution when desired.

Thus, when the user is ready to execute the treatment plan, he or she may cause the method 400 to proceed to a step 490 in which the treatment plan is executed. Execution of the treatment plan may entail providing the treatment 340 via playback of the trigger media file selection(s) 332 and/or the agreeable media file selection(s) for the patient, as applicable. Playback may be carried out according to the playback settings 336. Advantageously, execution of the treatment plan may be within the control of the patient. Thus, rather than receiving the impression that he or she is being subjected to the treatment plan at the behest of a different individual, he or she may recognize that he or she is in control of the treatment to be used.

After execution of the treatment plan has finished, the method 400 may proceed to a step 495 in which the treatment record 350 for the treatment 340 is stored, for example, in the treatment history 239, as described in connection with FIG. 3.

The method 400 may be implemented in a wide variety of ways. Although the various steps of the method 400 are shown and described in a certain order, those of skill in the art will recognize that the steps of the method 400 may be executed in many different order combinations from those set forth in the description of FIG. 4. Furthermore, some of the steps of the method 400 are optional and may be omitted and/or replaced with other steps not specifically described in the preceding discussion.

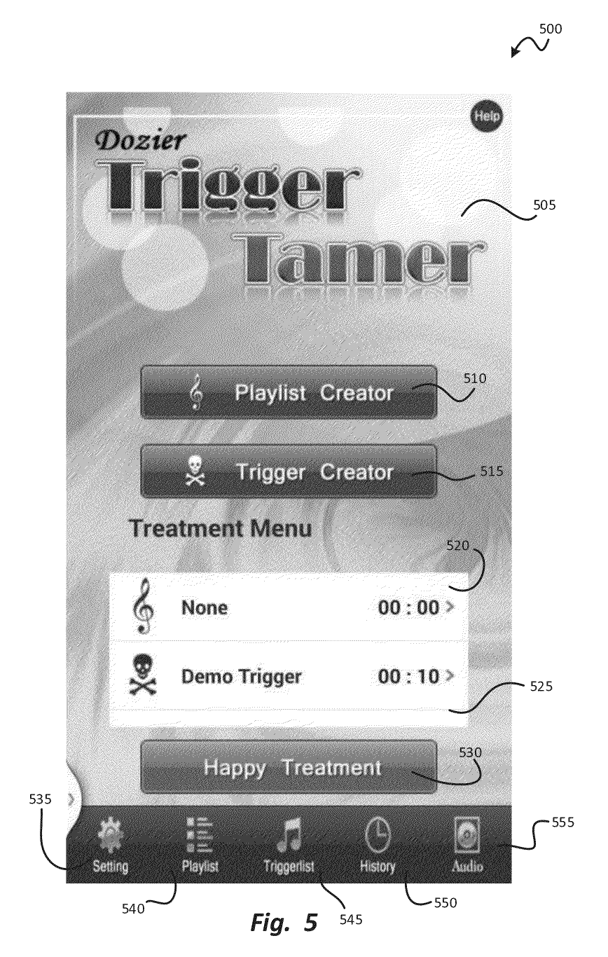

FIGS. 5-13 illustrate one exemplary user interface that may be used to carry out the method 400. The user interface of FIGS. 5-13 may also implement the schema of FIG. 3. FIGS. 5-13 relate specifically to an app for a smartphone such as the smartphone 126 of FIGS. 1-2B. However, those of skill in the art will recognize that the present invention may be implemented in a wide variety of computing devices, and with a wide variety of user interfaces besides that of FIGS. 5-13.

Referring to FIG. 5, a screenshot illustrates a home screen 500 according to one embodiment of the invention. The home screen 500 may be the screen that is initially shown (after the display of an optional loading screen, credits screen, or the like) when the app is started. The home screen 500 may have a title 505, and may provide several different navigation options.

More specifically, the home screen 500 may have a playlist creator button 510, a trigger creator button 515, a playlist widget 520, a triggerlist widget 525, and a treatment button 530. In addition, in a horizontal menu at the bottom of the screen, the home screen 500 may have a settings button 535, a playlist button 540, a triggerlist button 545, a history button 550, and an audio button 555. Some of the options in the menu at the bottom of the screen may be duplicative of those found elsewhere on the home screen 500 to provide multiple ways for a user to access the same functionality.

The playlist widget 520 may show the playlist (i.e., the ordered list of agreeable media files included in the current treatment plan). Similarly, the triggerlist widget 525 may show the triggerlist (i.e., the ordered list of trigger media files included in the current treatment plan). In some embodiments, the playlist and/or the triggerlist may be limited to only one media file for the appropriate type. For example, if the current treatment plan is focused on treatment for a particular trigger stimulus, the triggerlist may beneficially include only one trigger media file, which provides the trigger stimulus for which treatment is desired. In such a case, the playlist widget 520 and/or the triggerlist widget 525 may each display the name of the corresponding agreeable media file or trigger media file rather than the name of a playlist or triggerlist.

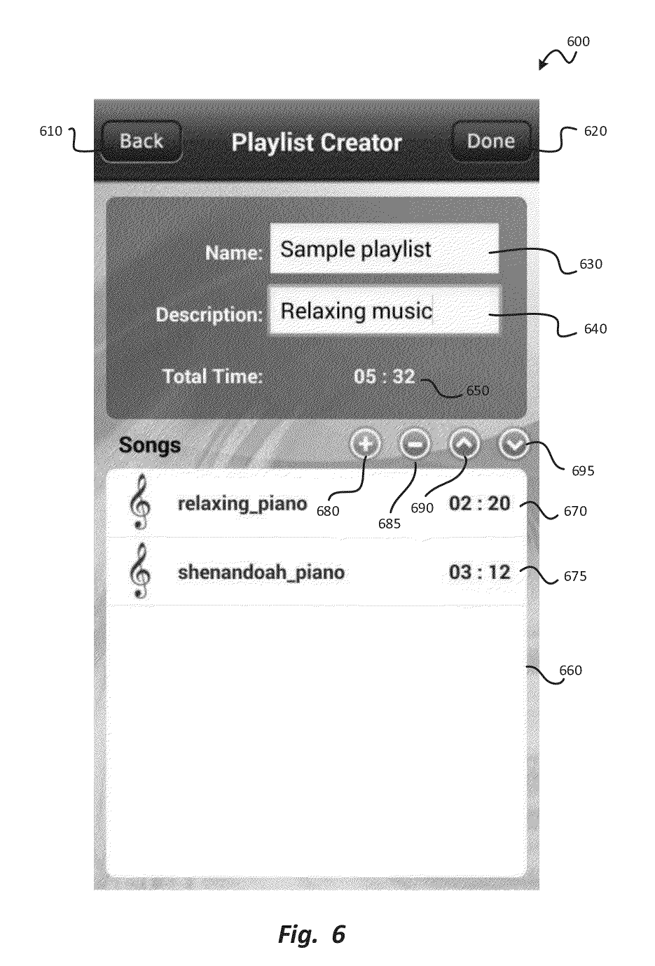

The various buttons and widgets on the home screen may be used to display other screens. These will be shown and described in connection with FIGS. 6-13, as follows.

Referring to FIG. 6, a screenshot illustrates a playlist creator screen 600 according to one embodiment of the invention. The playlist creator screen 600 may be displayed in response to a user tapping on the playlist creator button 510. The playlist creator screen 600 may enable the creation of a playlist, including one or more agreeable media file selections 334, for the treatment plan.

As shown, the playlist creator screen 600 may have a back button 610, which may display the home screen 500 without saving any changes made, and a done button 620, which may display the home screen 500 and save any changes made by the user on the playlist creator screen 600. This may be done, for example, by saving a new playlist created by the user.

In a name box 630, the user may enter the name of the new playlist (for example, “Sample playlist”). In a description box 640, the user may enter a description for the new playlist (for example, “Relaxing music”). The description may be wording that helps the user recall the contents and/or purpose of the playlist. A total time indicator 650 may indicate the total length of the playlist.

A selection view window 660 may list the media file(s) that are currently selected for inclusion in the playlist. As shown in FIG. 6, a first agreeable media selection 670 and a second agreeable media selection 675 may be shown in the selection view window 660. The agreeable media selections in the selection view window 660 may be displayed in order of playback. Thus, if the playlist of FIG. 6 is played, the first agreeable media selection 670 may be played back first, and then the second agreeable media selection 675.

A plus button 680 may be used to add an agreeable media file to the selection view window 660; thus, when a user presses the plus button 680, a media selection screen (not shown) may be displayed to allow the user to make a selection from the media files stored on the computing device (for example, the smartphone 126). Once the user has made a selection from the media selection screen, the selected media file may be shown in the selection view window 660, below the agreeable media file selections that are already shown.

A minus button 685 may be used to remove an agreeable media selection from the selection view window 660, and thence, from the playlist. The user may first tap on the agreeable media selection to be removed, and may then tap on the minus button 685 to remove the selected agreeable media selection.

The order of the agreeable media selections in the selection view window 660 may easily be adjusted through the use of an up button 690 and a down button 695. The user may simply select the agreeable media selection to be moved upward in the playlist (i.e., to cause that agreeable media selection to move up or down), and then tap the up button 690 to move the selected agreeable media selection one slot higher in the selection view window 660, and thence in the playlist, or tap the down button 695 to move the selected agreeable media selection one slot lower in the selection view window 660. Repeated taps of the up button 690 or the down button 695 may cause the selected agreeable media selection to move multiple slots upward or downward. Thus, the agreeable media selections in the playlist can be ordered according to the preference of the user.

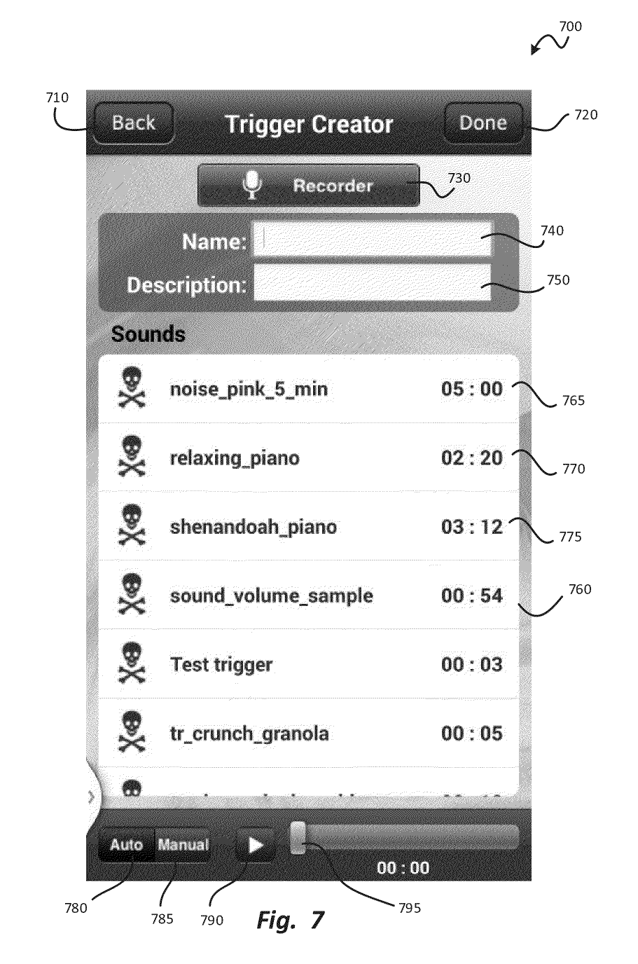

Referring to FIG. 7, a screenshot illustrates a trigger creator screen 700 according to one embodiment of the invention. The trigger creator screen 700 may be displayed in response to the user tapping on the trigger creator button 515 of the home screen 500 of FIG. 5. The trigger creator screen 700 may enable the user to create a trigger media file and/or designate one or more media files to be used as trigger media files.

The trigger creator screen 700 may have a layout similar to that of the playlist creator screen 600. As shown, the trigger creator screen 700 may have a back button 710, which may display the home screen 500 without saving any changes made, and a done button 720, which may display the home screen 500 and save any changes made by the user on the trigger creator screen 700. This may be done, for example, by saving a new trigger media file created or designated by the user.

The trigger creator screen 700 may also have a recorder button 730, which may be pressed to initiate capture of trigger stimuli in a trigger media file. This capturing may be done with the user input(s) 260 of the smartphone 126, such as a microphone for capturing auditory stimuli, and a camera for capturing visual stimuli. A microphone and a camera may be used to capture audiovisual stimuli. The user may tap the recorder button 730 to initiate capture, and then tap the recorder button again 730 to stop capturing and save the resulting media file.

The trigger creator screen 700 may also have a name box 740 and a description box 750. These may function in a manner similar to that of the name box 630 and the description box 640 of the playlist creator screen 600.

Furthermore, the trigger creator screen 700 may have a selection view window 760 that displays media files that can be used as trigger media files. The selection view window 760 may be made for selection of only a single trigger media file as opposed to multiple media files, as with the selection view window 660 of FIG. 6. Accordingly, there may be no need for a separate media selection screen, as described in connection with the plus button 680 of FIG. 6. The selection view window 760 may instead operate as a media selection screen. The user may simply tap on any of the media files shown, such as the first trigger media file 765, the second trigger media file 770, or the third trigger media file 775, to select the trigger media file to be used for treatment.

The trigger creator screen 700 may also have an auto button 780 and a manual button 785. In some embodiments, the auto button 780 may be used to automatically adjust characteristics of a trigger media file. Such characteristics may include setting the volume at which it will be played back, cropping the trigger media file to remove any leading silence or other undesirable portions, or the like. The manual button 785 may optionally be used to open a trigger editor screen (not shown) in which the user can manually adjust such characteristics. Such a trigger editor screen may allow the user to select the playback volume of the trigger media file, crop the trigger media file to remove undesired portions, and/or make other changes to the trigger media file.

The trigger creator screen 700 may also have a play button 790 and a slider bar 795. The play button 790 may be used to initiate playback of the trigger media file that has been selected on the selection view window 760. The slider bar 795 may be used to shift the playback to commence from a certain point in the selected trigger media file.

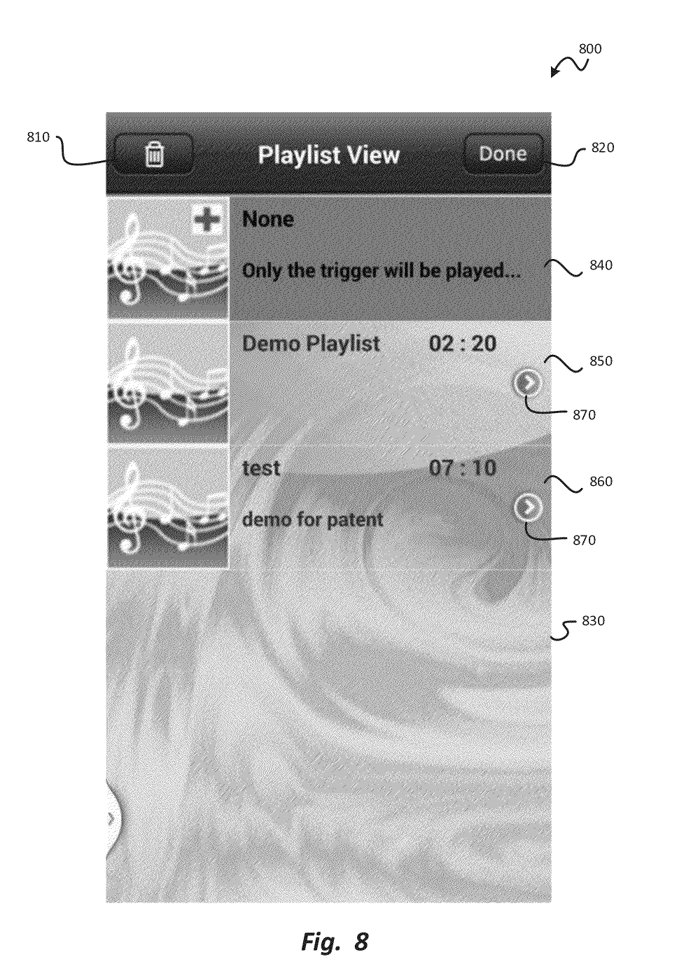

Referring to FIG. 8, a screenshot illustrates a playlist view screen 800 according to one embodiment of the invention. The playlist view screen 800 may be displayed in response to the user tapping on the playlist widget 520 of the home screen 500 of FIG. 5. The playlist view screen 800 may enable the user to view, select, change, and/or delete playlists that have been created, for example, via the playlist creator screen 600.

The playlist view screen 800 may have a delete button 810 and a done button 820. The delete button 810 may be used to delete a selected playlist, and the done button 820 may again display the home screen 500. The playlist view screen 800 may also have a playlist view window 830, which may display the playlists available for use on the smartphone 126.

As shown in FIG. 8, the playlist view window 830 may show a null playlist 840 that includes no media files. The null playlist 840 may be used to enable treatment without any agreeable media selections. The playlist view window 830 may also show a first playlist 850 and a second playlist 860, which may have been previously created and stored by the user, for example, from the playlist creator screen 600. The user may tap on the null playlist 840, the first playlist 850, or the second playlist 860 to select it, and then tap the delete button 810 or the done button 820 to delete the selected playlist or select it for treatment, respectively.

Each playlist displayed in the playlist view window 830 may also have a change button 870. When the user taps on the change button 870, the playlist creator screen 600 may again be displayed, with the details of the selected playlist (for example, the playlist name, description, length, and contents) already shown in the corresponding portions of the playlist creator screen 600 (for example, the name box 630, the description box 640, the total time indicator 650, and the selection view window 660). The user may then edit the playlist by adding, deleting, and/or reordering the agreeable media selections as discussed in the description of FIG. 6. When the user taps on the done button 620 of the playlist creator screen 600, the playlist view screen 800 may again be displayed.

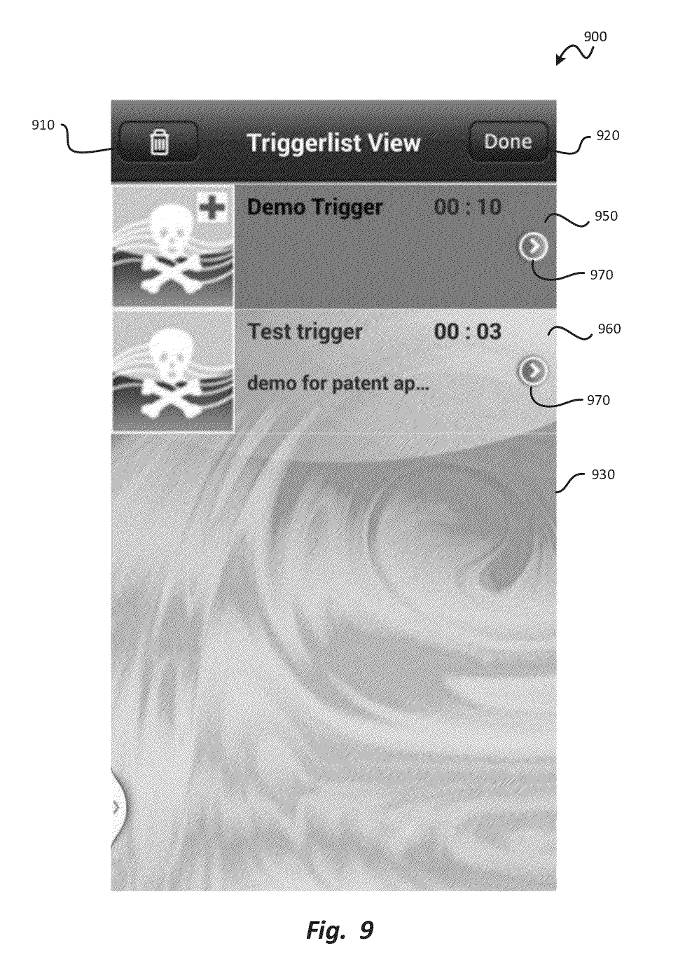

Referring to FIG. 9, a screenshot illustrates a triggerlist view screen 900 according to one embodiment of the invention. The triggerlist view screen 900 may be displayed in response to the user tapping on the triggerlist widget 525 of the home screen 500 of FIG. 5. The triggerlist view screen 900 may enable the user to view, select, change, and/or delete triggerlists that have been created, for example, via the trigger creator screen 700. The triggerlist view screen 900 may have a layout and function similar to those of the playlist view screen 800.

The triggerlist view screen 900 may have a delete button 910 and a done button 920. The delete button 910 may be used to delete a selected triggerlist, and the done button 920 may again display the home screen 500. The triggerlist view screen 900 may also have a triggerlist view window 930, which may display the triggerlists available for use on the smartphone 126.

As shown in FIG. 9, the triggerlist view window 930 show a first triggerlist 950 and a second triggerlist 960, which may have been previously created and stored by the user, for example, from the trigger creator screen 700. The user may tap on the first triggerlist 950 or the second triggerlist 960 to select it, and then tap the delete button 910 or the done button 920 to delete the selected triggerlist or select it for treatment, respectively.

Each triggerlist displayed in the triggerlist view window 930 may also have a change button 970. When the user taps on the change button 970, the trigger creator screen 700 may again be displayed, with the details of the selected triggerlist (for example, the triggerlist name, description, and contents) already shown in the corresponding portions of the trigger creator screen 700 (for example, the name box 740, the description box 750, and the selection view window 760). The user may then edit the triggerlist by adding or deleting the trigger media selections as discussed in the description of FIG. 7. As mentioned previously, each triggerlist may optionally be designed to contain only a single trigger media file. When the user taps on the done button 720 of the trigger creator screen 700, the triggerlist view screen 900 may again be displayed.

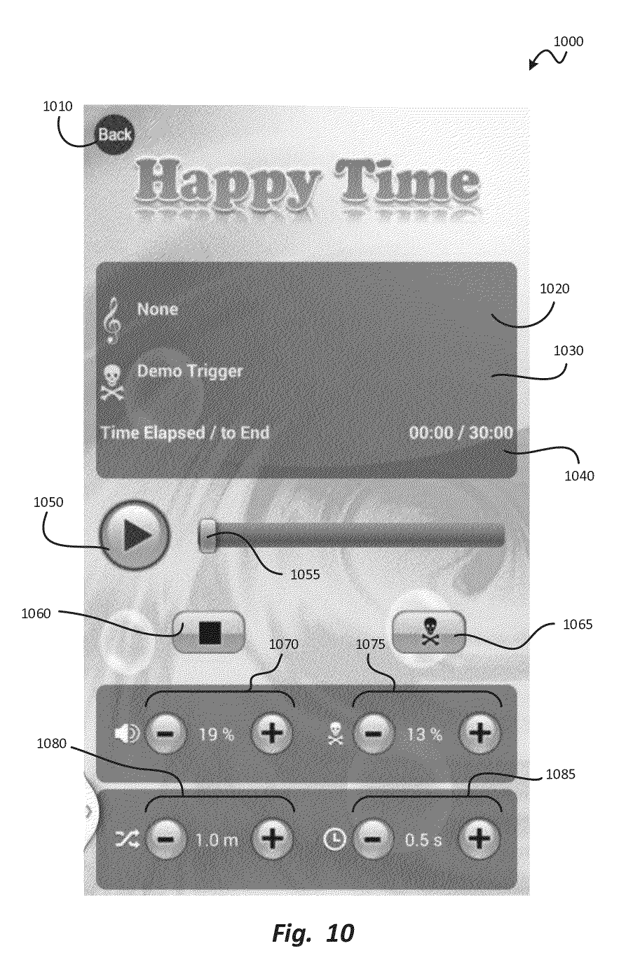

Referring to FIG. 10, a screenshot illustrates a treatment screen 1000 according to one embodiment of the invention. The treatment screen 1000 may be displayed in response to the user tapping on the treatment button 530 of the home screen 500 of FIG. 5. The treatment screen 1000 may enable the user to execute a treatment plan that has been previously created, for example, via the playlist creator screen 600 of FIG. 6 and the trigger creator screen 700 of FIG. 7.

The treatment screen 1000 may have a back button 1010 that can be used to return to the home screen 500 while treatment continues or to stop execution of the treatment plan and return to the home screen 500. The treatment screen 1000 may also have a playlist window 1020 that shows which playlist has been selected for the current treatment plan. This may be the same playlist shown in the playlist widget 520 of the home screen 500 of FIG. 5. The treatment screen 1000 may also have a triggerlist window 1030 that shows which triggerlist has been selected for the current treatment plan. This may be the same triggerlist shown in the triggerlist widget 525 of the home screen 500 of FIG. 5. A time window 1040 may show the total length of the treatment, along with the elapsed time.

A play button 1050 may be used to commence (or recommence) execution of the treatment plan. When the user taps on the play button 1050, playback of the playlist may commence, with intermittent playback of the triggerlist according to the playback settings 336 selected by the user for the treatment plan. During execution of the treatment plan, the play button 1050 may change to a pause button (not shown), which can be tapped by the use to pause execution of the treatment plan and enable execution to be recommenced via tapping on the play button 1050 again. A time slider 1055 may provide visual representation of the time progress in treatment and/or be used to shift playback of the treatment plan to a desired time. A stop button 1060 may stop execution of the treatment plan and return to the beginning of the treatment plan; this may entail resetting the time elapsed indication in the time window 1040 to zero and moving the time slider 1055 back to the left-hand side, indicating the return to the beginning of the treatment plan. A trigger button 1065 may enable the user to initiate playback of the triggerlist. In some embodiments, playback of the triggerlist can be initiated regardless of whether the treatment plan is currently being executed.

The bottom of the treatment screen 1000 may have various options that can be used to control the manner in which the treatment plan is executed. These options may be in addition to the options selected in the playback setting 336 of the treatment plan, or they may be used to override the playback setting 336.

As shown in FIG. 10, these options may include a master volume adjustment 1070, a trigger volume adjustment 1075, a trigger playback frequency adjustment 1080, and a trigger duration adjustment 1085. These options are merely examples of options that can be provided for treatment plan execution, and will be described below.

The master volume adjustment 1070 may be used to adjust the volume at which the treatment plan, as a whole, is executed. The master volume adjustment 1070 may be used in addition to or in place of the system volume for the smartphone 126. A setting of 19% may mean the treatment plan will be played at 19% of maximum volume for the smartphone 126, or that the treatment plan will be played at 19% of the system volume for the smartphone 126, which may already be less than 100%.

The trigger volume adjustment 1075 may be used to set the volume of the triggerlist relative to that of the playlist. Advantageously, this may enable patients to commence treatment with trigger stimuli played at a low enough volume that their reaction is substantially avoided. The patient may, with successive treatments and/or during treatment, use the trigger volume adjustment 1075 to raise the volume of the triggerlist relative to that of the playlist. A setting of 13% may mean that the triggerlist plays at 13% of the volume of the playlist.

The trigger playback frequency adjustment 1080 may determine the length of time between iterations of playback of the triggerlist and/or the time at which playback of the triggerlist first occurs. Thus, a setting of 1.0 minutes may mean that playback of the triggerlist will first occur one minute after the start of execution of the treatment plan, and may also mean that playback of the triggerlist will be initiated at one-minute increments thereafter. Advantageously, the patient may commence with infrequent trigger playback, and increase the trigger playback frequency with successive treatments and/or during treatment as his or her sensitivity to the trigger stimuli is reduced.

The trigger duration adjustment 1085 may be used to determine how long each triggerlist is played in each iteration. Thus, a setting of 0.5 seconds may mean that playback of the triggerlist will only last for one-half second each time the triggerlist is played. Advantageously, the patient may commence with a very short trigger playback duration, and increase the length of the triggerlist playback with successive treatments and/or during treatment as his or her sensitivity to the trigger stimuli is reduced.

As indicated above, the options at the bottom of the treatment screen 1000 may optionally be changed during the performance of a treatment. This may beneficially give the patient the control necessary to tailor execution of the treatment plan to his or her needs without having to stop the treatment plan and begin again.

More specifically, the patient may be able to use these options to make execution of the treatment plan occur at a more aggressive level, if he or she is comfortable with the way treatment is progressing. This may be done, for example, by increasing the master volume with the master volume adjustment 1070, increasing the trigger volume with the trigger volume adjustment 1075, increasing the trigger frequency with the trigger playback frequency adjustment 1080, and/or increasing the trigger duration with the trigger duration adjustment 1085. Conversely, if execution of the treatment plan is perceived to be too aggressive, as may be the case if the patient is experiencing excessive anxiety, anger, fear, or other negative reactions, these options may be used to adjust the currently occurring instance of execution of the treatment plan to a less aggressive level.

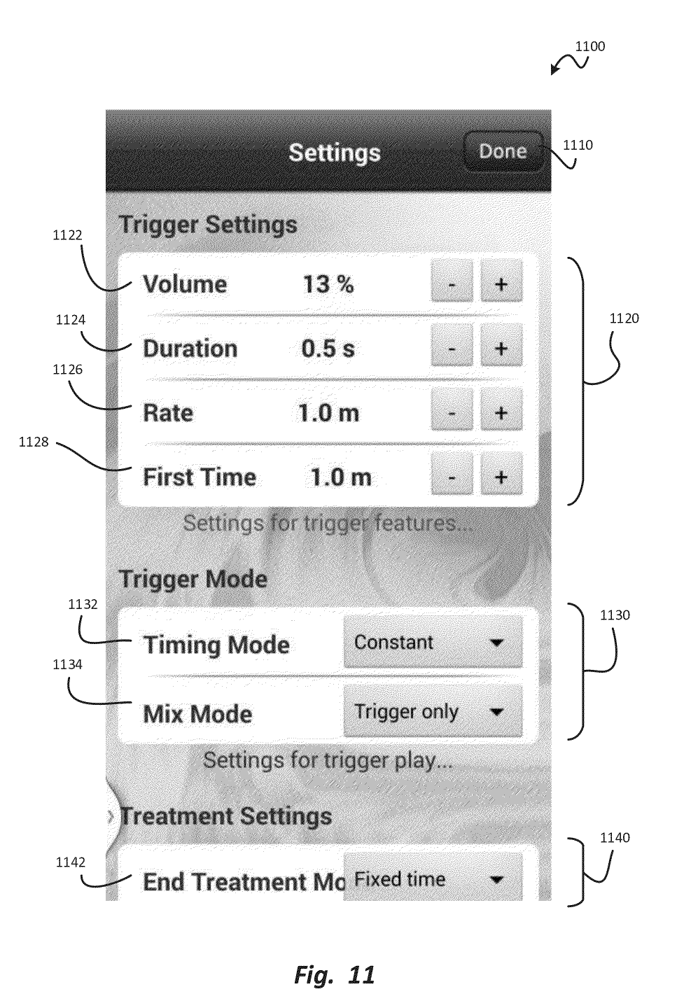

Referring to FIG. 11, a screenshot illustrates a settings screen 1100 according to one embodiment of the invention. The settings screen 1100 may be displayed in response to the user tapping on the settings button 535 of the home screen 500 of FIG. 5. The settings screen 1100 may enable the user to select various other settings applicable to the creation, storage, and/or execution of treatment plans. These settings may be stored in the preferences 238 of the data store 230.

The settings screen 1100 may have a done button 1110, which may be used to save any changes made to the settings on the settings screen 1100 and return to the home screen 500 of FIG. 5. Additionally, the settings screen 1100 may have a variety of settings, which may be grouped into trigger settings 1120, trigger mode settings 1130, and treatment settings 1140.

The trigger settings 1120 may include a volume setting 1122, a duration setting 1124, a rate setting 1126, and a first time setting 1128. The volume setting 1122 may be used to set the volume of triggerlist playback relative to that of playlist playback in a manner similar to that of the trigger volume adjustment 1075 of the treatment screen 1000. The duration setting 1124 may be used to set the length of triggerlist playback in a manner similar to that of the trigger duration adjustment 1085 of the treatment screen 1000. The rate setting 1126 may be used to set the frequency of triggerlist playback in a manner similar to that of the trigger playback frequency adjustment 1080 of the treatment screen 1000. These adjustments may be used globally to determine the default settings applied to their counterparts on the treatment screen 1000. Thus, if desired, the trigger volume adjustment 1075, the trigger playback frequency adjustment 1080, and the trigger duration adjustment 1085 may be able to override the global settings provided by the volume setting 1122, the duration setting 1124, and the rate setting 1126.

The trigger settings 1120 may also include a first time setting 1128. The first time setting 1128 may be used to determine the time, during treatment plan execution, at which triggerlist playback will initially occur. It may be advantageous to set the first time setting 1128 to a different time than that of the rate setting 1126. For example, a patient may wish to settle into a playlist for some time, and then once he or she has had sufficient time (for example, several minutes) to acclimate, commence playback of the triggerlist at an interval shorter (for example, one minute or less) than the delay applied prior to the first triggerlist playback instance.

The trigger mode settings 1130 may include a timing mode setting 1132 and a mix mode setting 1134. The timing mode setting 1132 may have the options “constant” and “variable,” and may be used to determine whether a constant time interval (such as a constant one minute interval) or a variable time interval should be applied. If the timing mode setting 1132 is set to “constant,” the interval between iterations of triggerlist playback may be the time period selected for the rate setting 1126 of the trigger settings 1120. If the timing mode setting 1132 is set to “variable,” the interval between iterations of triggerlist payback may have random variation. In such a case, the average interval between iterations of triggerlist playback may optionally be the time period selected for the rate setting 1126.

The mix mode setting 1134 may have the options “trigger only,” “reduce playlist,” and “mix, and may be used to determine how playback of the playlist is affected when playback of the triggerlist occurs. If the mix mode setting 1134 is set to “trigger only,” playback of the playlist may pause for the duration of triggerlist playback, and then resume once triggerlist playback is complete. If the mix mode setting 1134 is set to “reduce playlist,” playlist playback may continue during triggerlist playback, but at a reduced volume. If desired, selection of “reduce playlist” may initiate the display of a selection window (not shown) that enables the user to select the reduced volume to be applied to playlist playback while the triggerlist plays. The reduced volume may be expressed as a percentage, for example, a 30% reduced volume, which may entail playback of the playlist at 30% of its ordinary volume during playback of the triggerlist. If the mix mode setting 1134 is set to “mix,” playback of the playlist may continue during triggerlist playback, with no volume reduction. This may have the same effect as selecting “reduce playlist” for the mix mode setting 1134, and then selecting a 100% reduced volume.

The treatment settings 1140 may include an end of treatment mode setting 1142. The end of treatment mode setting 1142 may have the options “fixed time,” “fixed time for triggers,” and “end of playlist.” If the end of treatment mode setting 1142 is set to “fixed time,” execution of the treatment plan may occur for a fixed period of time, such as 30 minutes, regardless of the length of the playlist and/or triggerlist. This fixed period of time may be set in a selection window (not shown), which may be displayed below the end of treatment mode setting 1142. With the “fixed time” setting, the treatment length may be the fixed period of time, regardless of the length of the playlist. If the playlist is shorter than the fixed period of time, playback of the playlist may be repeated until the fixed period of time has elapsed.

If the end of treatment mode setting 1142 is set to “fixed time for triggers,” execution of the treatment plan may occur with intermittent triggers for a fixed period of time, such as 30 minutes. The selection window (not shown) may again be used to select the fixed period of time. The playlist may again repeat if it is shorter than the fixed period of time. After the fixed period of time has elapsed, playback of the playlist may continue until the next end of the playlist is reached, without playback of the triggerlist.

If the end of treatment mode setting 1142 is set to “end of playlist,” execution of the treatment plan may continue until the end of a fixed period of time, which may again be selected in the selection window (not shown). The playlist may again repeat if it is shorter than the fixed period of time. After the fixed period of time has elapsed, playback of the playlist may continue, with continued triggerlist playback, until the next end of the playlist is reached.

Returning briefly to FIG. 5, the horizontal menu at the bottom of the home screen 500 may have some alternative navigation options to those that appear elsewhere in the home screen 500. For example, tapping on the playlist button 540 may display the playlist view screen 800 of FIG. 8. Similarly, tapping on the triggerlist button 545 may display the triggerlist view screen 900 of FIG. 9.

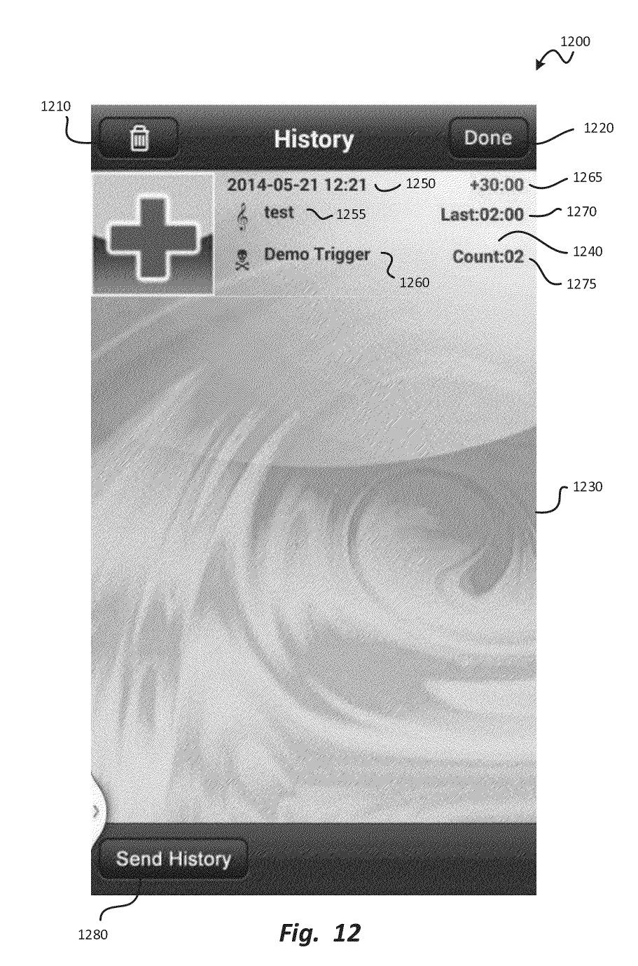

Referring to FIG. 12, a screenshot illustrates a history screen 1200 according to one embodiment of the invention. The history screen 1200 may be displayed in response to the user tapping on the history button 550 of the home screen 500 of FIG. 5. The history screen 1200 may enable the user to view and/or send treatment records regarding treatment plans that have been executed.

As shown, the history screen 1200 may have a delete button 1210 and a done button 1220. The delete button 1210 may be used to delete a selected treatment record, and the done button 1220 may again display the home screen 500. The history screen 1200 may also have a record view window 1230, which may display the treatment records for treatments, i.e., instances of treatment plan execution, that have been carried out on the smartphone 126.

The record view window 1230 may display a treatment record for each instance of execution of the treatment plan, and may thus display multiple treatment records. Only a first treatment record 1240 is shown in the record view window 1230 of FIG. 12. The first treatment record 1240 may provide various information regarding the corresponding instance of execution of the treatment plan.

For example, the first treatment record 1240 may indicate the date and time 1250 at which execution of the treatment plan was commenced or completed, the playlist 1255 used in the treatment plan, and/or the triggerlist 1260 used in the treatment plan. These may be the same as those shown in the playlist widget 520 and the triggerlist widget 525 of the home screen 500 of FIG. 5 at the time the treatment plan was executed, and may also be the same as the playlist window 1020 and the triggerlist window 1030 of the treatment screen 1000 of FIG. 10 at the time the treatment plan was executed.

The first treatment record 1240 may also indicate the length of the treatment plan 1265, which may be the same as the treatment plan length from the time window 1040 of the treatment screen 1000 when the treatment plan was executed. This may be the nominal length of the treatment plan, not the duration for which the treatment plan was actually executed. The first treatment record 1240 may also indicate the actual length 1270 of execution of the treatment plan. Thus, the first treatment record 1240 may indicate that the treatment plan had a nominal length of 30 minutes, but the user only executed the treatment plan for a total of two minutes. If desired, the actual length 1270 may indicate only the duration for which playback of the playlist was carried out, exclusive of the duration of triggerlist playback.

The first treatment record 1240 may also indicate a count 1275, which may be the number of times triggerlist playback was performed. Thus, the first treatment record 1240 may indicate that, during the corresponding instance of treatment plan execution, the triggerlist was only played back twice.

As shown, the history screen 1200 may also have a send history button 1280, which may be tapped to initiate transmission of the selected treatment record to a recipient. If desired, tapping on the send history button 1280 may cause the smartphone 126 to display a send screen (not shown), which may provide the user with multiple different ways to communicate the selected treatment record. For example, the send screen may enable the user to:
Store the treatment record locally to a different location on the smartphone 126;
Store the treatment record online at a virtual server such as Dropbox, OneDrive, or Google Drive;
Send the treatment record via e-mail or text; and/or
Post the treatment record to a social media site such as Facebook, Twitter, Google+, or Flipboard.

In this manner, treatment records can easily be stored for future use or communicated to others. In one example, the send history button 1280 may be used by a patient to transmit his or her treatment record(s) to a mental health professional, behavioral scientist, or other care provider.

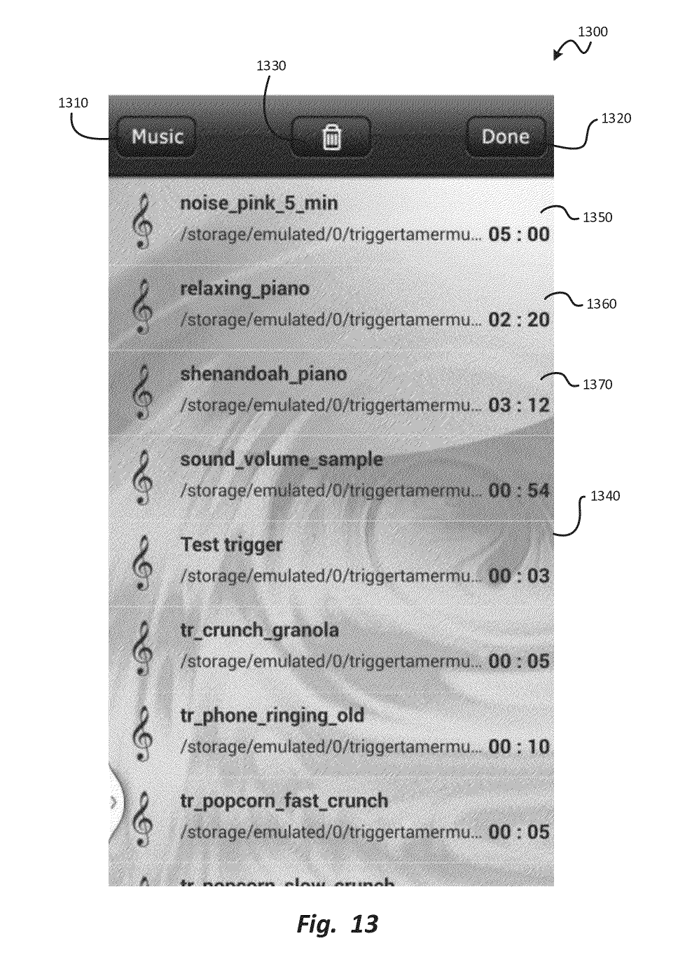

Referring to FIG. 13, a screenshot illustrates an audio browser screen 1300 according to one embodiment of the invention. The audio browser screen 1300 may be displayed in response to the user tapping on the audio button 555 of the home screen 500 of FIG. 5. The audio browser screen 1300 may enable the user to view, add, and/or delete media files that can be used in a playlist or triggerlist.

As shown, the audio browser screen 1300 may have a music button 1310, a done button 1320, and a delete button 1330. The music button 1310 may be used to browse other locations, besides the default media file storage location for the computer program product of FIGS. 5-13, to locate media files to be displayed on the audio browser screen 1300. This may be done through the use of a separate window (not shown). The done button 1320 may again display the home screen 500. The delete button 1330 may be used to delete a selected media file.

The audio browser screen 1300 may also have a media file view window 1340, which may display one or more media files that can be used, for example, in a playlist or triggerlist. As shown in FIG. 13, the media file view window 1340 may have a first media file 1350, a second media file 1360, and a third media file 1370. The media files shown in the audio browser screen 1300 may, by default, be those that have been generated by, provided with, or otherwise stored the a reference location for the computer program product of FIGS. 5-13. The music button 1310 may be used to add media files, or the delete button 1330 may be used to delete media files.

In the example of FIG. 13, the media files shown in the media file view window 1340 are audio files that provide only auditory stimuli. However, as mentioned previously, trigger stimuli and/or auditory stimuli to be provided to a patient may be auditory, visual, or audiovisual. Thus, in an alternative example (not shown) to that of FIGS. 5-13, a computer program product may permit capture, selection, playback, ordering, deletion, and/or other functions for other media types besides the audio files shown in FIG. 13. In order to use visual or audiovisual media, various preview screens may be used so that a user can view image or video files. A treatment screen like that of FIG. 10 may be provided, but may show such images or video in a window, or may switch to full-screen display.

Such an example may provide a variety of settings and options different from those disclosed in the discussion of the computer program product of FIGS. 5-13. Such settings and options may include, but are not limited to:
Blurring applied to visual media for the playlist and/or triggerlist;
Dimming applied to visual media for the playlist and/or triggerlist;
A delay between playback of audio and visual portions of an audiovisual media file;
Recoloring applied to visual media for the playlist and/or triggerlist;
Full or partial obscuring and/or occlusion applied to visual media for the playlist and/or triggerlist; and
Transitions such as fading in and out, blurring, and the like, applied between instances of playback of visual media, for example, between agreeable media files and trigger media files.

Any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, Figure, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. Elements recited in means-plus-function format are intended to be construed in accordance with 35 U.S.C. §112 Para. 6. It will be apparent to those having skill in the art that changes may be made to the details of the above-described embodiments without departing from the underlying principles of the invention.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. A computer program product for treating a psychological disorder in a patient, the computer program product comprising:
a non-transitory storage medium; and
computer program code, encoded on the non-transitory storage medium, wherein the computer program code is configured to cause at least one processor to perform the steps of:
causing a data store to store a trigger media set comprising one or more trigger media files that encode trigger stimuli known to trigger symptoms of the psychological disorder, the trigger stimuli comprising at least one of auditory stimuli, visual stimuli, and audiovisual stimuli;
causing the data store to store a treatment plan comprising a first trigger selection comprising a first trigger media file of the one or more trigger media files; and
causing a processor to execute the treatment plan by intermittently initiating playback of the first trigger selection for the patient through at least a first output device.

2. The computer program product of claim 1, wherein the psychological disorder is misophonia, wherein the first trigger media file comprises auditory stimuli to which the patient is extraordinarily sensitive and the first output device comprises a speaker, wherein initiating playback of the first trigger selection comprises playing the auditory stimuli through the speaker.

3. The computer program product of claim 1, wherein the psychological disorder is a phobia, wherein the first trigger media file comprises visual stimuli that invoke fear in the patient and the first output device comprises a display screen, wherein initiating playback of the first trigger selection comprises displaying the visual stimuli on the display screen.

4. The computer program product of claim 1, wherein the computer program code is further configured to cause the at least one processor to cause a first input device to receive a first user input selected from the group consisting of:
a selection to store the first trigger media file in the data store;
a selection to include the first trigger media file in the treatment plan;
a selection to execute the treatment plan;
a selection to stop execution of the treatment plan;
a selection of a duration of playback of the first trigger media file;
a selection of a trigger volume level at which playback of the first trigger media file occurs;
a selection of a volume level change applied between intermittent initiations of playback of the first trigger media file;
a selection of a length of time applied between intermittent initiations of playback of the first trigger media file; and
a selection of a length of the treatment plan.

5. The computer program product of claim 1, wherein the computer program code is further configured to cause the at least one processor to cause the data store to store an agreeable media set comprising one or more agreeable media files that encode agreeable stimuli known to be agreeable to the patient, the agreeable stimuli comprising at least one of auditory stimuli, visual stimuli, and audiovisual stimuli;
wherein the treatment plan further comprises a first agreeable selection comprising a first agreeable media file of the one or more agreeable media files;
wherein causing the processor to execute the treatment plan further comprises initiating playback of the first agreeable selection for the patient prior to initiation of intermittent playback of the first trigger selection.

6. The computer program product of claim 5, wherein the computer program code is further configured to cause the at least one processor to cause a first input device to receive a first user input selected from the group consisting of:
a first selection to store the first agreeable media file in the data store;
a first selection to include the first agreeable media file in the treatment plan;
a first selection to execute the treatment plan;
a first selection to stop execution of the treatment plan;
a first selection of a duration of playback of the first trigger media file;
a first selection of a trigger volume level at which playback of the first trigger media file occurs relative to an agreeable volume level at which playback of the first agreeable media file occurs;
a first selection of a volume level change applied between intermittent initiations of playback of the first trigger media file;
a first selection of a length of time applied between intermittent initiations of playback of the first trigger media file; and
a first selection of a length of the treatment plan.

7. The computer program product of claim 6, wherein the computer program code is further configured to cause the at least one processor to cause a first input device to receive, during execution of the treatment plan, a second user input selected from the group consisting of:
a second selection of a duration of playback of the first trigger media file;
a second selection of a trigger volume level at which playback of the first trigger media file occurs relative to an agreeable volume level at which playback of the first agreeable media file occurs;
a second selection of a volume level change applied between intermittent initiations of playback of the first trigger media file; and
a second selection of a length of time applied between intermittent initiations of playback of the first trigger media file;
wherein the computer program code is further configured, in response to receipt of the second user input, to alter execution of the treatment plan in accordance with the second user input, without re-starting execution of the treatment plan.

8. The computer program product of claim 5, wherein the treatment plan further comprises a second agreeable selection comprising a second agreeable media file of the one or more agreeable media files, and a playlist comprising an order of playback specifying playback of the second agreeable selection after playback of the first agreeable selection;
wherein the second agreeable media file is different from the first agreeable media file;
wherein causing the processor to execute the treatment plan further comprises initiating playback of the second agreeable selection for the patient after completion of playback of the first agreeable selection for the patient.

9. The computer program product of claim 5, wherein the computer program code is further configured to cause the at least one processor to execute the treatment plan by initiating playback of the first trigger media file prior to termination of playback of the first agreeable media file such that playback of at least a portion the first trigger media file is simultaneous with playback of at least a portion of the first agreeable media file.

10. The computer program product of claim 9, wherein the computer program code is further configured to cause the at least one processor to execute the treatment plan by reducing a volume of playback of the first agreeable media file during playback of the first trigger media file.

11. The computer program product of claim 5, wherein the computer program code is further configured to cause the at least one processor to execute the treatment plan by pausing playback of the first agreeable media file prior to or concurrently with initiation of playback of the first trigger media file, and by resuming playback of the first agreeable media file after termination playback of the first trigger media file.

12. The computer program product of claim 1, wherein the treatment plan further comprises a second trigger selection comprising a second trigger media file of the one or more trigger media files;
wherein the second trigger media file is different from the first trigger media file;
wherein causing the processor to execute the treatment plan further comprises initiating playback of the second trigger selection for the patient after completion of playback of the first trigger selection for the patient.

13. The computer program product of claim 1, wherein the computer program code is further configured to cause the at least one processor to execute the treatment plan by initiating playback of the first trigger selection by playing the first trigger media file at reduced clarity.

14. The computer program product of claim 1, wherein intermittently initiating playback of the first trigger selection comprises:
initiating a first instance of playback of the first trigger selection;
completing the first instance of playback of the first trigger selection;
after passage of a first time period following completion of playback of the first trigger selection, initiating a second instance of playback of the first trigger selection;
completing the second instance of playback of the first trigger selection; and
after passage of a second time period following completion of playback of the second trigger selection, initiating a third instance of playback of the first trigger selection;
wherein the second time period is different from the first time period.

15. A method for treating a psychological disorder in a patient through the aid of a computing system, the method comprising:
in a data store, storing a trigger media set comprising one or more trigger media files that encode trigger stimuli known to trigger symptoms of the psychological disorder, the trigger stimuli comprising at least one of auditory stimuli, visual stimuli, and audiovisual stimuli;
in the data store, storing a treatment plan comprising a first trigger selection comprising a first trigger media file of the one or more trigger media files;
in a processor, executing the treatment plan by intermittently initiating playback of the first trigger selection for the patient through at least a first output device.

16. The method of claim 15, further comprising:
in the data store, storing an agreeable media set comprising one or more agreeable media files that encode agreeable stimuli known to be agreeable to the patient, the agreeable stimuli comprising at least one of auditory stimuli, visual stimuli, and audiovisual stimuli;
wherein the treatment plan further comprises a first agreeable selection comprising a first agreeable media file of the one or more agreeable media files;
wherein executing the treatment plan further comprises initiating playback of the first agreeable selection for the patient prior to initiation of intermittent playback of the first trigger selection.

17. The method of claim 16, further comprising, at a first input device, receiving a first user input selected from the group consisting of:
a selection to store the first trigger media file in the data store;
a selection to include the first trigger media file in the treatment plan;
a selection to store the first agreeable media file in the data store;
a selection to include the first agreeable media file in the treatment plan;
a selection to execute the treatment plan;
a selection to stop execution of the treatment plan;
a selection of a duration of playback of the first trigger media file;
a selection of a trigger volume level at which playback of the first trigger media file occurs;
a selection of a trigger volume level at which playback of the first trigger media file occurs relative to an agreeable volume level at which playback of the first agreeable media file occurs;
a selection of a volume level change applied between intermittent initiations of playback of the first trigger media file;
a selection of a length of time applied between intermittent initiations of playback of the first trigger media file; and
a selection of a length of the treatment plan.

18. A system for treating a psychological disorder in a patient through the aid of a computing system, the system comprising:
a data store configured to:
store a trigger media set comprising one or more trigger media files that encode trigger stimuli known to trigger symptoms of the psychological disorder, the trigger stimuli comprising at least one of auditory stimuli, visual stimuli, and audiovisual stimuli; and
store a treatment plan comprising a first trigger selection comprising a first trigger media file of the one or more trigger media files;
a first output device; and
a processor communicatively coupled to the data store and the first output device, wherein the processor is configured to execute the treatment plan by intermittently initiating playback of the first trigger selection for the patient through at least the first output device for the patient.

19. The system of claim 18, wherein the data store is further configured to store an agreeable media set comprising one or more agreeable media files that encode agreeable stimuli known to be agreeable to the patient, the agreeable stimuli comprising at least one of auditory stimuli, visual stimuli, and audiovisual stimuli;
wherein the treatment plan further comprises a first agreeable selection comprising a first agreeable media file of the one or more agreeable media files;
wherein the processor is further configured to execute the treatment plan by initiating playback of the first agreeable selection for the patient prior to initiation of intermittent playback of the first trigger selection.

20. The system of claim 19, further comprising a first input device configured to receive a first user input selected from the group consisting of:
a selection to store the first trigger media file in the data store;
a selection to include the first trigger media file in the treatment plan;
a selection to store the first agreeable media file in the data store;
a selection to include the first agreeable media file in the treatment plan;
a selection to execute the treatment plan;
a selection to stop execution of the treatment plan;
a selection of a duration of playback of the first trigger media file;
a selection of a trigger volume level at which playback of the first trigger media file occurs;
a selection of a trigger volume level at which playback of the first trigger media file occurs relative to an agreeable volume level at which playback of the first agreeable media file occurs;
a selection of a volume level change applied between intermittent initiations of playback of the first trigger media file;
a selection of a length of time applied between intermittent initiations of playback of the first trigger media file; and
a selection of a length of the treatment plan.
